(19) United States
(12) Patent Application Publication
(10) Pub. No.: US 2006/0283090 A1
(43) Pub. Date: Dec. 21, 2006

(54) Adjustable doorway threshold

(76) Inventor: Ronald E. Moody, Tuscon, AZ (US)

Correspondence Address: Donald L. Wenskay, 132 North E1 Camino Real, Suite 314, Encinitas, CA, 92024, US

(21) Appl. No.: 10/307,266

(22) Filed: Nov. 27, 2002

(51) Int. Cl. E06B 1/70

(52) U.S. Cl. 49/467

(57) ABSTRACT

An adjustable doorway threshold that has at least one side which is moveable to change its height to compensate for differing adjacent floor heights. In one embodiment of the invention the doorway threshold includes an elongated central member having a raised horizontal longitudinal surface and a longitudinal edge. A ramp member, approximately the same length as the central member, is disposed with its inner edge adjacent to the longitudinal edge of the central member. The ramp member has an outer edge disposed at a lower horizontal elevation than the raised longitudinal horizontal surface of the central member. The ramp member is hingeably attached at its inner edge to the longitudinal edge of the central member such that the outer edge of the ramp member is moveable vertically with respect to the central member. The threshold ramp member is disposed over the top of the flooring material and not adjacent to the edge of the floor material. A spring may be disposed underneath the ramp member to push the ramp downward onto the flooring material beneath.

### FIELD OF THE INVENTION

The present invention relates to the field of doorway thresholds, and more particularly to a doorway threshold that adjusts on at least one side to varying floor heights.

### BACKGROUND OF THE INVENTION

Doorway thresholds generally consist of a raised member disposed below a door when the door is in a closed position. Thresholds serve a number of purposes in building construction. They are typically used for exterior doors, where it is important to provide a good seal below the door to isolate the interior space from the exterior elements. Since the top surface of the threshold is at a higher level than the interior or exterior floor surfaces, the weatherseal element on the bottom of the door makes contact with the threshold but not the adjacent floor material. Without the threshold, the weatherseal would need to be at the same level with the floor and hence would make contact with the floor material even when the door is opened. This would interfere with the operation of the door and would cause excessive wear on the floor and weatherseal.

Thresholds serve other purposes. Since the interior and exterior flooring materials are typically made of different materials, the threshold provides a uniform surface to make sealing contact with the weatherseal element at the bottom of the door. Without the threshold, the differing flooring materials would not allow an effective seal to be achieved.

One longstanding problem with doorway thresholds results from the aforementioned different flooring materials on the interior and exterior floors. In particular, the different flooring materials, as well as different underlying base floor material, means that the threshold is usually adjacent to floors of differing heights on its interior and exterior edges. This means that the interior edge of the threshold abuts a floor of a different height than its exterior edge. However, since thresholds need to be mass produced in particular standard sizes, the same threshold must be used for many different floor materials and heights. As a result, the threshold edge might be too high or too low depending on the height of the floor it is adjacent to. If the threshold is too high or too low it might cause persons to trip. Also the height mismatch results in an undesirable appearance.

One example of an existing threshold that was developed to deal with the differing floor heights is U.S. Pat. No. 5,673,517. In this patent one side of the threshold is configured to be coupled with interlocking modular sections which ramp down to a lower floor level. However, this design adds significantly to the material and labor cost and makes the threshold wider than may be desirable. Further, this threshold only allows a fixed incremental height adjustment to be made by adding the modular sections. While this threshold may be desirable where there is an unusually large difference in floor heights, it is unable to make smaller adjustments for varying floor heights. Other adjustable thresholds, such as U.S. Pat. Nos. 4,146,995, 4,352,258 and 6,185,870, provide for an adjustment in the height of the center surface that makes contact with the weatherseal, but do not allow different heights of the edges that abut the floor surfaces.

Hence, it would be desirable to provide a doorway threshold that has at least one edge that is adjustable in height to match the height of adjacent flooring. In addition, it would be desirable to provide such an adjustable threshold that is adjustable to any desired height, within a range, and not just to discrete predetermined heights. It would also be desirable to provide an adjustable doorway threshold that is cost effective to manufacture and install. It would also be desirable to provide a doorway threshold with the above features that is esthetic in appearance and does not present an abrupt edge that persons might trip over.

The above-described needs are addressed by the present invention.

### SUMMARY OF THE INVENTION

An adjustable doorway threshold that has at least one side which is moveable to change height to compensate for differing adjacent floor heights. In one embodiment of the invention the doorway threshold includes an elongated central member having a raised horizontal longitudinal surface and first and second longitudinal edges. A ramp member, approximately the same length as the central member, is disposed with an inner edge adjacent to the first longitudinal edge of the central member. The ramp member has an outer edge disposed at a lower horizontal elevation than the raised longitudinal horizontal surface of the central member. The ramp member is hingeably attached at its inner edge to the first longitudinal edge of the central member such that the outer edge of the first ramp member is moveable vertically with respect to the central member. The threshold ramp member is designed to be disposed over the top of adjacent flooring material instead of abutting against the edge of the floor material. As a result, the edge of the flooring material is concealed, resulting in an improved appearance. A spring may be disposed underneath the ramp member to push the ramp downward onto the flooring material beneath.

The doorway threshold of the present invention permits installation where it is adjacent to a wide variety of flooring materials with varying heights, without having a mismatch between the heights of the edges of the threshold and floor. As a result, the appearance is greatly improved, costs are lower, and the chance of tripping at the threshold edge is reduced.

### BRIEF DESCRIPTION OF THE FIGURES

FIG. 1 shows a perspective view of an adjustable doorway threshold in accordance with one embodiment of the invention.

FIG. 2 shows a cross-sectional view, taken at the centerline, of the adjustable doorway threshold shown in FIG. 1.

FIG. 3, shows a cross-sectional view, taken at the centerline, of low-profile adjustable doorway threshold in accordance with a second embodiment of the invention.

FIG. 4 shows a cross-sectional view of a hinge portion of the fixed threshold member of the low-profile adjustable doorway threshold shown in FIG. 3.

FIG. 5 shows a cross-sectional view of a hinge portion of a moveable element of the low-profile adjustable doorway threshold shown in FIG. 3.

FIG. 6 shows a cross-sectional view, taken at the centerline, of a high-profile adjustable doorway threshold in accordance with a third embodiment of the invention.

### DETAILED DESCRIPTION OF THE DRAWINGS

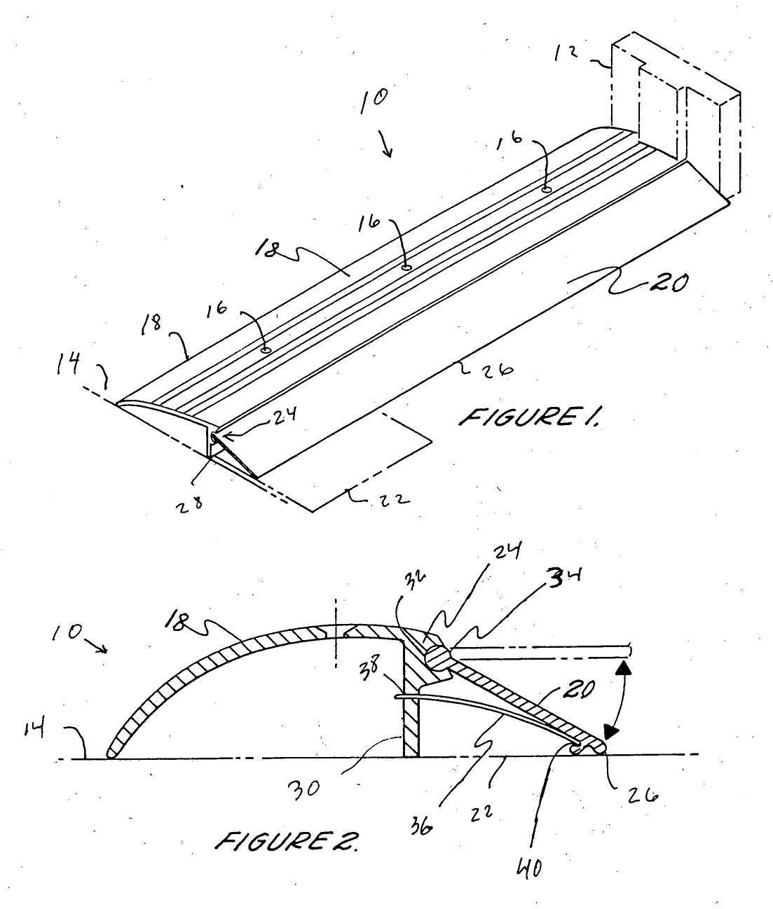

FIG. 1 shows a perspective view of an adjustable doorway threshold 10 in accordance with one preferred embodiment of the invention. A portion of an adjacent door frame 12 is also shown. The threshold 10 is mounted to a floor 14 by means of a plurality of screws 16, or other fasteners. The doorway threshold 10 includes a fixed threshold member 18 and a moveable threshold member 20. The moveable threshold member 20 is disposed to rest on top of a flooring material 22, which may consist of a wide variety of flooring materials, such as carpet, tile, wood, stone, marble, slate, etc. The moveable threshold member 20 is attached to the fixed threshold member 18 by means of a hinge unit 24, which permits the moveable floor unit 20 to be raised and lowered at its outer edge 26.

There are at least two different ways to install the adjustable doorway threshold 10. In some installations it will be desirable to install the adjustable threshold 10 before the flooring material 22. In a first installation method of the invention, after the adjustable threshold 10 is installed by means of the screws 16, the moveable member outer edge 26 can be manually raised. The flooring material 22 is then slid under the moveable member 20 so that the edge 28 of the flooring material is concealed under the moveable member 20. In the other optional installation method according to the invention, the flooring material 22 is installed first. The adjustable threshold 10 is then installed such that the moveable member 20 is overlapping with the flooring material 22. Note that due to the operation of the hinge unit 24, the moveable member 20 will automatically be raised or lowered by a desired amount to accommodate a variety of thicknesses of flooring materials 22. A spring (shown in FIG. 2) insures that the moveable member 20 remains snugly pressed down onto the flooring material 22.

FIG. 2 shows a cross-sectional view of the adjustable threshold 10 shown in FIG. 1. The fixed member 18 is shown including a support leg 30 which extends downward and rests on the floor 14. The hinge unit 24 is shown as including a rounded slot 32 in the fixed threshold member 18. A rod-pin 34 in the moveable threshold member 20 rotatably engages with the slot 32 to form the hinge unit 24. The rod-pin 34 has an outer radius that is slightly smaller than the outer radius of the slot 32 to permit rotation therein. The moveable threshold member 20 is shown in solid lines at its lower position and in phantom at its upper position. A leaf spring 36 is attached at one side to a slot 38 in the support leg 30 and at its other side to a slot 40 at the lower edge 26 of the moveable threshold member 20. The leaf spring 36 is biased such that it will always push the moveable threshold member 20 downward to maintain a snug contact with the flooring material 22 regardless of the height of the flooring material.

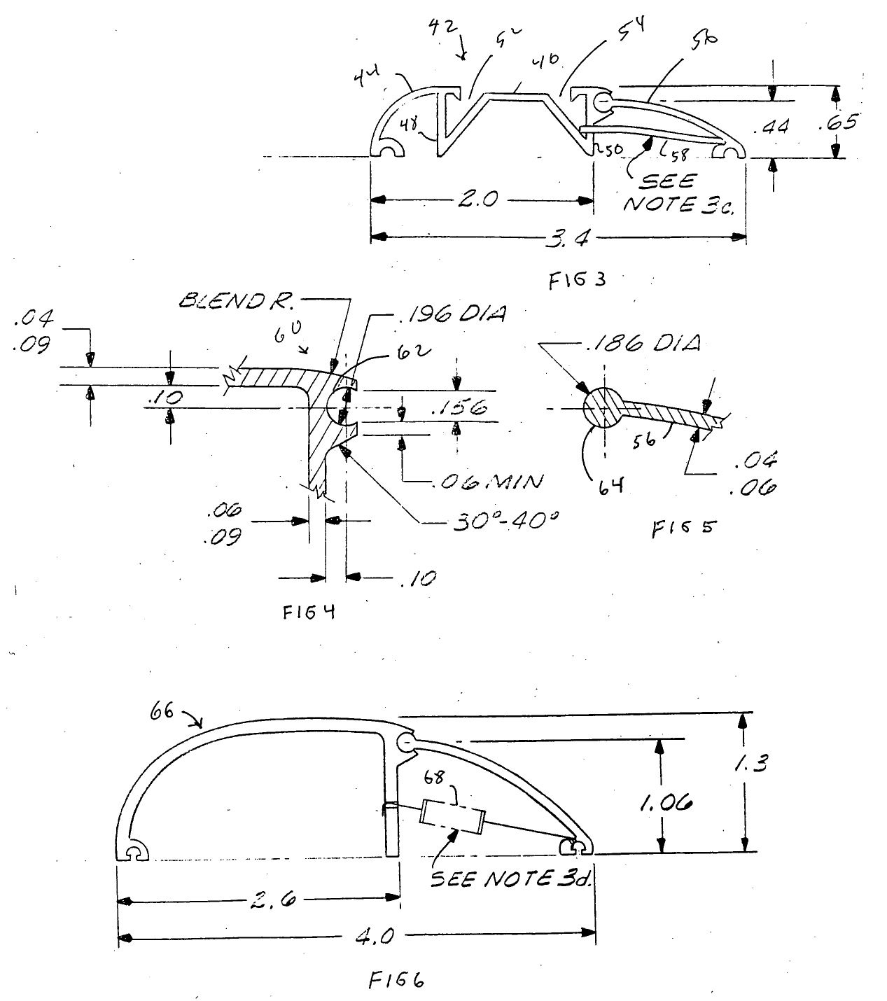

FIG. 3 shows a second embodiment of an adjustable doorway threshold 42 of the present invention. The adjustable threshold 42 in FIG. 3 is adapted to a low-profile configuration. Thus the fixed threshold member 44 has a flat upper surface 46 and two support legs 48 and 50. This configuration includes recesses portions 52 and 54, which may be used to attach a weather strip (not shown). The adjustable threshold 42 includes a moveable member 56 and a leaf spring 58 to permit the raising and lowering of the moveable member in the same manner as the threshold 10 shown in FIG. 1. The leaf spring 58 is preferably made from a one inch wide piece of 0.04″ or 0.06″ ABS or Styrene plastic sheet. In a three foot long threshold, a single spring 58 located at the centerline of the length is recommended. In a six foot or longer threshold, two equally spaced springs are recommended. The fixed threshold member and the moveable threshold members 4 and 56 are preferably made of extruded aluminum. The aluminum material should be similar to conventional aluminum threshold products. However, other materials used for thresholds, such as wood, can also be used. The adjustable threshold 42 in FIG. 3 provides about ⅜ inch of vertical adjustment of the moveable threshold member to accommodate different flooring material heights.

FIGS. 4 and 5 show additional details and dimensions of this embodiment of the hinge unit 60. In particular, FIG. 4 shows the hinge slot 62 and associated dimensions. FIG. 5 shows rod-pin 34 and associated dimensions of this embodiment.

FIG. 6 shows a cross-sectional view of another embodiment of a doorway threshold 66 of the present invention. This embodiment is a high-profile version of the invention, similar to the embodiment shown in FIGS. 1 and 2, but showing the dimensions of this particular embodiment. Also, in the threshold 62, instead of a leaf spring a coil spring 68 is used. As discussed above, longer thresholds should employ more than one equally spaced springs 68. The adjustable threshold 66 shown in FIG. 6 should provide about ⅝ inch of vertical adjustment to accommodate different flooring material heights.

The adjustable doorway threshold of the present invention provides a number of advantages. It allows a wide variety of different heights of flooring materials to be used without resulting in any abrupt change of height between the threshold and the floor, which would detract from the appearance and could present an edge that persons could trip over. Also, the overlapping of the moveable threshold member over the floor gives an improved esthetic appearance in comparison to conventional thresholds where the flooring material buts against the edge of the threshold.

Another advantage of the adjustable threshold results from the fact that the edge of the flooring material is concealed under the moveable member. Consequently, the tolerances for the flooring material edge can be looser than normal. This reduces the labor costs, since less accuracy is needed in the cutting and installing of the flooring at its edge 28. For example, in conventional installations, where the edge of the flooring material buts against the outer edge of the threshold, the flooring material must terminate at the threshold edge to within a very small tolerance or else gaps will be visible between the threshold and the flooring material. In general, the flooring edge should not vary more than about ¼ inch. With the adjustable threshold of the present invention, about two inches of the edge of the flooring material is concealed. Hence, wide variations in the location of the flooring edge will be entirely concealed beneath the moveable member. For example, variations of as much as 1-2 inches can be tolerated. Besides reducing the labor costs the threshold of the invention will reduce material costs. This is because flooring material that might otherwise not be usable because it is too short, or because it was inadvertently cut too short, can still be used as long as the edge is concealed beneath the moveable member edge. The resulting material cost savings can be significant, particularly when expensive flooring materials are used. Also, the need for grouting between the threshold and a hard flooring material can be eliminated because of the concealment of the edge, further reducing labor and material costs.

Numerous modifications to and alternative embodiments of the present invention will be apparent to those skilled in the art in view of the foregoing description. For example, the invention may be manufactured of a wide variety a materials. It may be used in a variety of types on construction and in both interior and exterior doors. Accordingly, this description is to be construed as illustrative only and is for the purpose of teaching those skilled in the art the best mode of carrying out the invention. Details of the structure and method may be varied substantially without departing from the spirit of the invention and the exclusive use of all the modifications, which come within the scope of the appended claims, is reserved.

What is claimed is:

1. A doorway threshold comprising:
elongated central member having a raised horizontal longitudinal surface and a longitudinal edge;
ramp member, approximately the same length as the central member disposed with an inner edge adjacent to the longitudinal edge of the central member, the ramp member having an outer edge disposed at a lower horizontal elevation than the raised longitudinal horizontal surface of the central member; and
the ramp member being hingeably attached at its inner edge to the first longitudinal edge of the central member such that the outer edge of the first ramp member is moveable vertically with respect to the central member.

2. A doorway threshold according to claim 1 further comprising:
spring having first and second ends attached to the bottom sides of the central and ramp members respectively, wherein the spring member is biased to move the ramp member downward vertically with respect to the central member.

3. A doorway threshold according to claim 2 wherein the spring is a coil spring.

4. A doorway threshold according to claim 2 wherein in the spring is a leaf spring.

5. A doorway threshold according to claim 2 further comprising at least one additional spring.

6. A doorway threshold according to claim 1 further comprising a second ramp member is hingeably attached to the central member.

7. A doorway threshold according to claim 1 wherein the central member includes a ramp portion having outer edges disposed at a lower horizontal elevation than the raised longitudinal horizontal surface of the central member.

8. A doorway threshold according to claim 1 wherein the central member and the ramp member are made of aluminum.

9. A method of installing a doorway threshold comprising the steps of:
placing a threshold having a central member and an adjustable ramp member in a doorway such that the adjustable ramp member is on top of and overlapping with a flooring material adjacent to the threshold;
pressing the threshold central member downward causing the adjustable ramp member to raise vertically with respect to the central member; and
securing the threshold to the floor in the doorway.

10. A method of installing a doorway threshold comprising the steps of:
securing a threshold having a central member and an adjustable ramp to a doorway floor;
lifting the adjustable ramp member;
installing a flooring material underneath the adjustable ramp member; and
releasing the adjustable ramp member so that it overlaps and presses down on to the flooring material.
